(19) United States
(12) Patent Application Publication
(10) Pub. No.: US 2025/0085718 A1
(43) Pub. Date: Mar. 13, 2025

(54) PATH PLANNING METHOD, DEVICE AND AUTOMATIC SNOW SWEEPER

(71) Applicant: SHENZHEN HANYANG TECHNOLOGY CO., LTD., Shenzhen (CN)

(72) Inventors: Yang HUANG, Shenzhen (CN); Chuwei ZHENG, Shenzhen (CN)

(73) Assignee: SHENZHEN HANYANG TECHNOLOGY CO., LTD., Shenzhen (CN)

(21) Appl. No.: 18/824,753

(22) Filed: Sep. 4, 2024

Related U.S. Application Data
(63) Continuation of application No. PCT/CN2024/080707, filed on Mar. 8, 2024.

(30) Foreign Application Priority Data
Sep. 11, 2023 (CN) 202311172351.6

(51) Int. Cl. G05D 1/648; E01H 5/06; G05D 1/246; G05D 105/00

(52) U.S. Cl. CPC G05D 1/648; E01H 5/06; G05D 1/246; G05D 2105/12

(57) ABSTRACT

Disclosed are a path planning method, a device and an automatic snow sweeper. The method includes the following steps: acquiring a snow throwing site and a current position of an automatic snow sweeper in a snow sweeping map; determining a snow throwing direction of the automatic snow sweeper based on the snow throwing site and the current position; planning a snow sweeping path conforming to a preset rule in the snow sweeping map based on the snow throwing direction; and controlling the automatic snow sweeper to move based on the snow sweeping path.

### CROSS-REFERENCE TO RELATED APPLICATIONS

This application is a continuation of International Application No. PCT/CN2024/080707, filed on Mar. 8, 2024, which claims priority to Chinese Patent Application No. 202311172351.6, filed on Sep. 11, 2023, titled “Path planning method, device and automatic snow sweeper”. All of the aforementioned applications are incorporated herein by reference in their entireties.

### TECHNICAL FIELD

The application relates to the technical field of automatic snow sweepers, in particular to a path planning method, a device and an automatic snow sweeper.

### BACKGROUND

The majority of snow sweeper operation modes in the prior art depend on manual control to direct the machine's movement for the selection of the best snow cleaning course. The inventors realized that there are a few clear drawbacks to the conventional approach.

Snow sweepers are not capable of intelligent path planning because they are manually operated. Manual operation is easily influenced by the personal experience and skills of the user, resulting in a lack of systematicity and scientificity in the selection of snow cleaning paths. Users find it challenging to fully take into account a variety of elements due to the complex weather and terrain circumstances. As a result, they may not plan the snow cleaning paths optimally, which leads to low efficiency and resource waste.

The information above is not an acknowledgment that it is prior art; rather, it is merely intended to aid in understanding the technical solution of this application.

### SUMMARY

The main purpose of the application is to propose a path planning method, a device, and an automatic snow sweeper in order to address the technical problem that, in the prior art, snow sweepers rely on human operation and cannot achieve intelligent path planning.

In order to achieve the above object, the present application provides a path planning method, which includes the following steps:
acquiring a snow throwing site and a current position of the automatic snow sweeper in a snow sweeping map;
determining a snow throwing direction of the automatic snow sweeper based on the snow throwing site and the current position;
planning a snow sweeping path conforming to a preset rule in the snow sweeping map based on the snow throwing direction; and
controlling the automatic snow sweeper to move based on the snow sweeping path.

In addition, in order to achieve the above purpose, the application also provides a path planning device, which includes:
a position acquisition module, configured for acquiring a snow throwing site and a current position of an automatic snow sweeper in a snow sweeping map;
a direction acquisition module, configured for determining a snow throwing direction of the automatic snow sweeper based on the snow throwing site and the current position;
a path acquisition module, configured for planning a snow sweeping path conforming to a preset rule in the snow sweeping map based on the snow throwing direction; and
a move execution module, configured for controlling the automatic snow sweeper to move based on the snow sweeping path.

In addition, in order to achieve the above purpose, the application also provides an automatic snow sweeper, which includes: a moving machine, a snow removal machine, a body and one or more control devices, and one or more control devices include a memory, a processor and a path planning program stored in the memory and executable on the processor, and the path planning program is configured to realize the following steps:
acquiring a snow throwing site and a current position of the automatic snow sweeper in a snow sweeping map;
determining a snow throwing direction of the automatic snow sweeper based on the snow throwing site and the current position;
planning a snow sweeping path conforming to a preset rule in the snow sweeping map based on the snow throwing direction; and
controlling the automatic snow sweeper to move based on the snow sweeping path.

The present application is realized as follows: acquiring a snow throwing site and a current position of an automatic snow sweeper in a snow sweeping map; determining a snow throwing direction of the automatic snow sweeper based on the snow throwing site and the current position; planning a snow sweeping path conforming to a preset rule in the snow sweeping map based on the snow throwing direction; and controlling the automatic snow sweeper to move based on the snow sweeping path. In this way, the snow sweeping path is optimally planned for the automatic snow sweeper, and the snow sweeping efficiency of the automatic snow sweeper is improved.

Details of one or more embodiments of the application are set forth in the following drawings and descriptions, and other features and advantages of the application will be apparent from the description, drawings and claims.

### BRIEF DESCRIPTION OF THE DRAWINGS

FIG. 1 is a structural schematic diagram of an automatic snow sweeper according to an embodiment of the present application.

FIG. 2 is a structural schematic diagram of a control device of a hardware operation environment according to an embodiment solution of the present application.

FIG. 3 is a flowchart of a path planning method according to the first embodiment of present application.

FIG. 4 is a flowchart of a path planning method according to the second embodiment of present application.

FIG. 5 is a schematic diagram of rasterization and potential field of a path planning method according to the second embodiment of present application.

FIG. 6 is a flowchart of a path planning method according to the third embodiment of present application.

FIG. 7 is a structural diagram of a path planning device according to the first embodiment of present application.

The purposes, implementations, technical features and advantages of the application will be further explained with reference to the attached drawings and embodiments.

### DETAILED DESCRIPTION OF THE EMBODIMENTS

It should be understood that the specific embodiments described herein are merely intended to clarify the application rather than limit it.

FIG. 1 shows a structural schematic diagram of an automatic snow sweeper according to an embodiment of the present application.

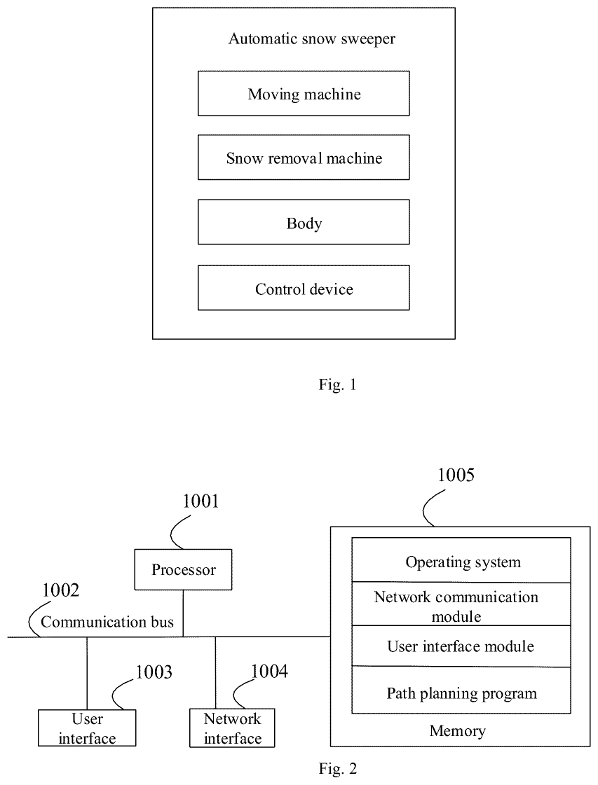

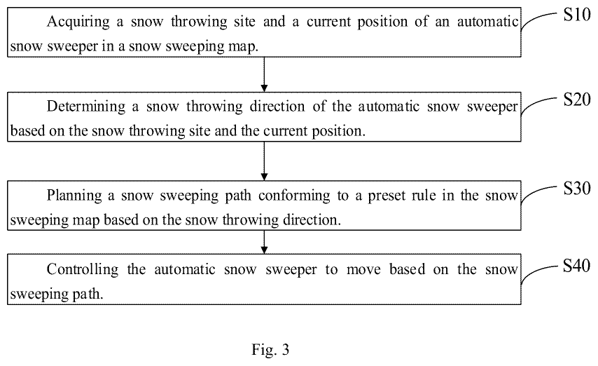

FIG. 2 shows a structural schematic diagram of a control device of a hardware operation environment according to an embodiment solution of the present application.

As shown in FIG. 2, the control device may include a processor 1001, such as a central processing unit (CPU), a communication bus 1002, a user interface 1003, a network interface 1004 and a memory 1005. The communication bus 1002 is used to realize connection communication between these components. The user interface 1003 may include a display, and the optional user interface 1003 may also include a standard wired interface and a wireless interface. The wired interface for the user interface 1003 may be a USB interface in this application. The network interface 1004 may optionally include a standard wired interface and a wireless interface, such as a WIreless-FIdelity (WI-FI) interface. The memory 1005 may be a high-speed Random Access Memory (RAM) memory or a Non-volatile Memory (NVM), such as a disk memory. The memory 1005 may alternatively be a storage device separate from the aforementioned processor 1001.

It can be understood by those skilled in the art that the structure shown in FIG. 2 does not impose restrictions on the control device, and that it may contain more or less components than shown, combine certain components, or have various component layouts.

As shown in FIG. 2, the memory 1005 as a computer storage medium may include an operating system, a network communication module, a user interface module and a path planning program.

In the control device shown in FIG. 2, the network interface 1004 is mainly used for connecting a background server and performing data communication with the background server. The user interface 1003 is mainly used for connecting peripherals. The path planning device calls the path planning program stored in the memory 1005 through the processor 1001, and executes the path planning method provided by the embodiment of the application.

Based on the above hardware structure, an embodiment of the path planning method of the present application is proposed.

FIG. 3 shows a flowchart of a path planning method according to the first embodiment of present application.

In the first embodiment, the path planning method includes the following steps:

Step S10: acquiring a snow throwing site and a current position of an automatic snow sweeper in a snow sweeping map.

It should be noted that the executive body of this embodiment may be a control device with functions of data processing, network communication and program running. The control device is used to control snow sweeper, and snow sweeper also includes a moving machine, a snow removal machine and a body. The control device can be understood as the controller of the automatic snow sweeper.

Understandably, the snow throwing site refers to that the automatic snow sweeper throws the snow to a specific position on the map after the snow cleaning operation is completed. This position may be set in advance or dynamically determined according to the needs of snow removal task. To make sure that throwing snow won't have a negative impact on the neighborhood, the snow throwing location may take into consideration nearby structures, roads, and other elements.

It should be understood that the current position refers to the real-time geographical position of the automatic snow sweeper during the snow sweeping task. With the sensor, snow sweeper can accurately obtain its own coordinates on the map, so as to keep an accurate perception of its own position during the whole working process.

In specific implementation, the automatic snow sweeper can acquire the information of the snow throwing site and the current position in the snow sweeping map by carrying various sensors or equipment, such as GPS, lidar, camera, etc. These sensors can accurately capture the location of the machine on the map and the information of the surrounding environment.

Understandably, the automatic snow sweeper can determine the snow throwing site according to the edge position in the snow sweeping map. Here, according to the environmental information, it is determined that some of the most marginal positions in the snow sweeping map are non-working areas, which can be regarded as snow throwing sites in this case. For example, according to the environmental information, the most marginal position away from the house and located in the snow sweeping map is taken as a snow throwing site.

It should be noted that the IMU sensor in the automatic snow sweeper can collect the slope of the ground and then determine the snow throwing site based on the slope. Here, when the snow is not thick, the more inclined the ground is, the more likely it is to cause the snow to roll. In this case, the determined snow throwing site may be flat ground. The way of IMU sensor to determine the snow throwing site on the flat ground may also be determined by visual sensor. The IMU sensor can also be used to determine the flat ground of the snow throwing site. Here, it is recognized that the ground is located on the same straight line through the visual sensor.

Step S20: determining a snow throwing direction of the automatic snow sweeper based on the snow throwing site and the current position.

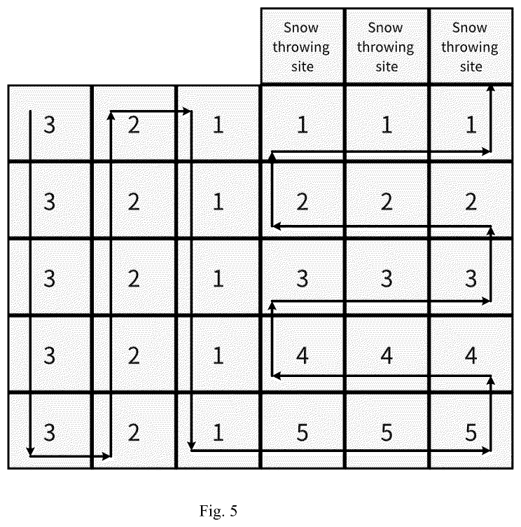

It should be noted that the snow throwing direction refers to the direction of the snow throwing barrel. When rasterization is performed on the snow sweeping map, the direction of the snow throwing barrel corresponding to the automatic snow sweeper in each grid can be obtained according to the snow throwing direction, and the snow throwing barrel of the automatic snow sweeper is controlled in the correct direction during snow sweeping. Here, performing rasterization on the snow sweeping map refers to dividing the snow sweeping map into multiple grids, and setting a corresponding potential energy value for each grid through Breadth-First Search (BFS). As shown in the right half of FIG. 5, for example, the potential energy value of the grid where the snow throwing site is located can be set to 0, and the potential energy value of the grid of the corresponding layer is increased by 1 every time it is expanded from the snow throwing site, and finally the potential energy value distribution image as shown in the right half of FIG. 5 is formed.

Step S30: planning a snow sweeping path conforming to a preset rule in the snow sweeping map based on the snow throwing direction.

It should be noted that the snow sweeping path of the preset rule may include a path a certain level of potential energy or a path formed after being blocked by obstacles (including a path affected by the connected area or a path formed after being blocked by static or dynamic obstacles). Here, the level of potential energy refers to the distance between the automatic snow sweeper and the snow throwing site (the farther the distance is, the greater the potential energy of snow throwing), as well as the direction (the more the direction of the sweeper is relative to the snow throwing site, the greater the potential energy of snow throwing). Affected by the connected area means that the regular bow-shaped cleaning of the sweeper is blocked by a large area of obstacles in the working area, and then multiple partitioned areas are formed in the working area, and each area may have at least one connected area, for example, the right half of FIG. 5 and the left half of FIG. 5 are two partitioned areas, and the boundary between the area with a grid potential energy value of 5 in the right half of FIG. 5 and the area with a grid potential energy value of 1 in the left half of FIG. 5 is a connected area. In this case, when the machine is moving, it first moves from high potential energy to low potential energy in the left half of FIG. 5, and finally determines the shortest path to the right half of FIG. 5 based on the position of the connected area, thus avoiding the sweeper from moving on too many invalid paths.

Step S40: controlling the automatic snow sweeper to move based on the snow sweeping path.

It should be noted that a bow-shaped path is adopted for the snow sweeping path of the automatic snow sweeper, which allows the sweeper body to move from high potential energy to low potential energy after the snow throwing site is determined (specifically, it includes sweeping the outer circle of the snow throwing site, throwing the snow from the outer circle into the snow throwing site, then cleaning the area where snow cannot be thrown into the snow throwing site, throwing the snow into the uncleaned area, and finally cleaning the area where snow can be thrown into the snow throwing site).

It should be understood that the snow sweeping mode of the automatic snow sweeper in this embodiment is that the snow is rolled up by the snow rolling blade, and then thrown by the snow throwing blade, and finally thrown into the snow throwing site set by the user through the snow throwing barrel. Therefore, the path planning needs to consider the snow throwing direction of each position, and all the snow in the working area is piled up at the snow throwing site through the path planning.

It should be noted that after the obstacles stop the snow from being thrown to the snow throwing site, the snow can be thrown to the area that has not been cleaned and can be thrown to the snow throwing site correctly, and then the snow can be thrown to the snow throwing site through this area, or multiple partitioned areas can be formed in the working area, and then the snow can be thrown to the snow throwing site through the connected areas between areas.

Understandably, after being partitioned, if the area of one area is too small for the sweeper to work or an obstacle prevents the snow from being thrown to the snow throwing site, the snow removal work in this area may not be carried out.

The first embodiment is realized as follows: acquiring a snow throwing site and a current position of an automatic snow sweeper in a snow sweeping map; determining a snow throwing direction of the automatic snow sweeper based on the snow throwing site and the current position; planning a snow sweeping path conforming to a preset rule in the snow sweeping map based on the snow throwing direction; and controlling the automatic snow sweeper to move based on the snow sweeping path. In this way, the snow sweeping path is optimally planned for the automatic snow sweeper, and the snow sweeping efficiency of the automatic snow sweeper is improved.

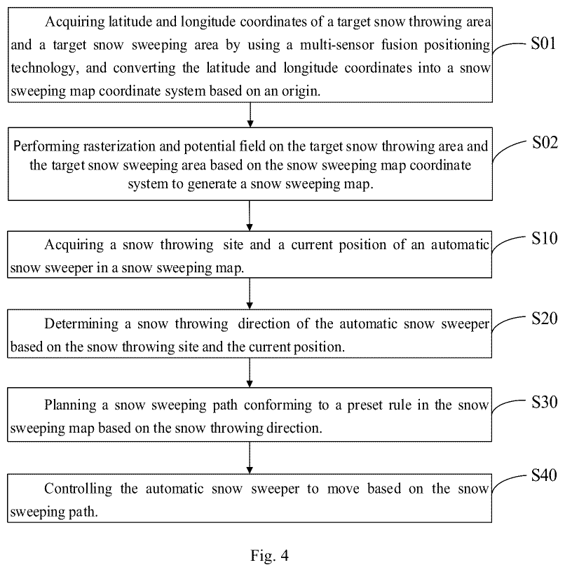

FIG. 4 shows a flowchart of a path planning method according to the second embodiment of present application. Based on the first embodiment shown in FIG. 3, the second embodiment of the path planning method of the present application is proposed.

In the second embodiment, before the Step S10, it further includes:

Step S01: acquiring latitude and longitude coordinates of a target snow throwing area and a target snow sweeping area by using a multi-sensor fusion positioning technology, and converting the latitude and longitude coordinates into a snow sweeping map coordinate system based on an origin.

It should be noted that the automatic snow sweeper includes a communication module, which can acquire the movement information sent by the mobile device. After the automatic snow sweeper has moved to the designated place through the movement information, the snow sweeping map of the automatic snow sweeper created using RTK-odometry-IMU fusion positioning technology. Here, the movement information refers to the information which is generated by manually operating the mobile device (handle) to control the automatic snow sweeper to move. The snow sweeping map is used to plan the path after the automatic snow sweeper has completed the positioning operation.

In specific implementation, the handle or app-control machine (the handle is controlled by wireless communication or the app-control machine is controlled by cloud server) controls the automatic snow sweeper to move, the GPS-RTK base station provides the positioning information to the cloud server, and the current automatic snow sweeper provides the positioning information to the cloud server, and the cloud server will combine the two to perform a differential to obtain the latitude and longitude and heading angle of the automatic snow sweeper, that is, the positioning of the automatic snow sweeper. Record the positioning to create a snow sweeping map. In addition, in this embodiment, the non-cloud (local) mode could be preferred: the GPS-RTK base station sends the positioning information to the sweeper through lora wireless communication, and the sweeper obtains the accurate positioning (the positioning includes latitude, longitude and heading angle) after performing a differential based on both its own positioning and the positioning of the base station. Furthermore, a charging point could be set, and a two-dimensional coordinate system covering the snow sweeping area can be generated with this charging point as the origin, so that the generated snow sweeping map can be visualized.

Step S02: performing rasterization and potential field on the target snow throwing area and the target snow sweeping area based on the snow sweeping map coordinate system to generate a snow sweeping map.

It should be noted that in the single area snow sweeping strategy, the step of performing rasterization and potential field on the target snow throwing area and the target snow sweeping area includes: 1. Gridding, finding the minimum bounding rectangle of the sweeping area, and establishing a coordinate system with the lower left corner as the origin and the rectangle length and width as the x-y axis to rasterize the sweeping area. The unit of the coordinate system is equivalent to the actual 0.3 m, and the center point of each grid is the target point where the sweeper moves. In order to ensure that the automatic planning can also be started near the edge of the snow sweeping area, the number of grids in a certain distance will be increased on the basis of the minimum bounding rectangle. 2. Potential field map, because the way of sweeping snow is to throw snow by the sweeper and finally pile snow in the snow throwing site, the potential energy at the snow throwing site is marked as the lowest, and then the farther away from the snow throwing site, the greater the potential energy. Based on this criterion, a potential energy value is added to all grids, and the path of sweeper is moving from high potential energy to low potential energy. Meanwhile, the snow throwing direction at each position also refer to throwing snow towards places with low potential energy, which can ensure that the snow will finally be collected in the place with low potential energy. 3. After rasterizing the map, marking the types of grids (cleaned, uncleaned, forbidden area, and snow throwing site), and combining a series of connected snow throwing grids together and mark them as a group. According to the upper, lower, left and right boundaries of the group, finding the most suitable direction of spreading potential energy (the longest side, for the purpose to move straight as much as possible to avoid turning), and marking the grids in the same row as the same potential energy from the lowest row, increase the potential energy of labels in rows in the spreading direction (the reason for marking one row is to follow a straight line with the same potential energy for the future planning path) until it reaches the boundary, and the spreading process adopts the breadth-first search algorithm. If it has spread to the whole area once, the potential field is completed, otherwise, the grid at the spreading boundary is taken as the new snow throwing site, and the above steps are repeated until the spreading is completed. During the spreading process, the snow throwing direction of each grid is marked at the same time, generally the grid with low potential energy before spreading; 4. Path generation, including: traversing the grids to find the grid with the largest potential energy in the area, and planning the path from this grid; moving along the grid with the same potential energy until reaching the boundary, then the adjacent grid with lower potential energy is found; finding out whether there is a grid with higher potential energy in the adjacent position of the grid; if yes, circularly finding the grid point with the highest potential energy position, planning a shortest cleaning path between the current cleaning position and the grid point with the adjacent highest potential energy position through the shortest path algorithm; repeating the above steps until the cleaning path comes to an end, and checking whether there is any uncleaned area in the area at the same time, otherwise, continuing to repeat the above steps until planning is completed.

Furthermore, in this embodiment, the step of planning a snow sweeping path conforming to a preset rule in the snow sweeping map based on the snow throwing direction includes: determining whether the snow sweeping map has a plurality of snow sweeping areas; determining, if the plurality of snow sweeping areas exist, whether the plurality of snow sweeping areas constitute a connected area; determining, if the connected area is constituted, a connection path connecting two adjacent snow sweeping areas; and planning a snow sweeping path conforming to a preset rule in the snow sweeping map based on the snow throwing direction and the connection path.

It should be understood that in the snow sweeping strategy of multiple sweeping areas, the strategy of multiple areas currently adopts Disjoint-set data structure to determine whether the areas constitute a connected area, and the Disjoint-set data structure refers to a data structure used to manage elements, which is usually used to handle the merging and searching operations of the sets. Each cleaning area is represented as a node, and the connection relationship between cleaning areas can be managed through the Disjoint-set data structure. When two areas are connected, they will be regarded as a connected area. If a connected area is formed, the breadth-first search algorithm is adopted to find a connection path connecting two adjacent snow sweeping areas, and the breadth-first search algorithm is a graph traversal algorithm, and its main feature is to traverse the nodes of the graph layer by layer from the starting node to find a specific target node, and the shortest path from the starting node to the target node can be calculated. In this embodiment, the shortest path between two cleaning areas is determined. Then the cleaning strategy in a single area continues to use the cleaning strategy in a single area. Here, the connection path may be the path determined by the user or the shortest path found by the sweeper based on the current position.

It should be noted, as shown in FIG. 5, which is a schematic diagram of rasterization and potential field of a path planning method of this application, each grid in the figure is a grid, and the figure is divided into two areas. The junction of numbers 1 and 5 is a connected area, and the larger the number, the greater the potential energy. In the process of snow sweeping planning, the automatic snow sweeper will move away from the snow throwing site in a bow shape first, and throw the snow to the grid near the snow throwing site, and finally, move to the grid near the snow throwing site. For example, the sweeper moves in the 3-2-1 area in the left of the snow throwing site first, then enters the right area from the connected areas 1 and 5, and enters the designated snow throwing site according to the path 5-4-3-2-1 to finish the snow throwing.

In the second embodiment, high-precision position information can be provided by GPS-RTK positioning technology, so that the latitude and longitude coordinates of the target snow throwing area and the snow sweeping area can be accurately captured. This high-precision positioning can ensure that the generated snow sweeping map is highly consistent with the actual geographical environment, thus providing an accurate basis for path planning and navigation. Performing rasterization and potential field on the target area means transforming continuous geographic information into discrete grids, and then embedding potential field information into them. Such optimization can better capture geographical features such as terrain, obstacles and slopes, and provide more accurate data for path planning. Potential field can simulate the interaction between objects, such as avoiding obstacles, thus making path planning more intelligent and flexible. The generated snow sweeping map can be presented in the form of grid or potential field, so that users can intuitively understand the geographical distribution of the target snow throwing area and snow sweeping area, as well as possible obstacles and terrain characteristics. Such visualizations can help users better understand the working environment and aid in planning and decision-making. The snow sweeping map based on grid and potential field can generate an intelligent snow sweeping path by combining advanced path planning algorithms with terrain, barriers, optimization strategy, and other factors. Such path planning allows the automatic snow sweeper to conduct snow cleaning tasks more efficiently and accurately, avoiding unwanted round trips and waste of resources.

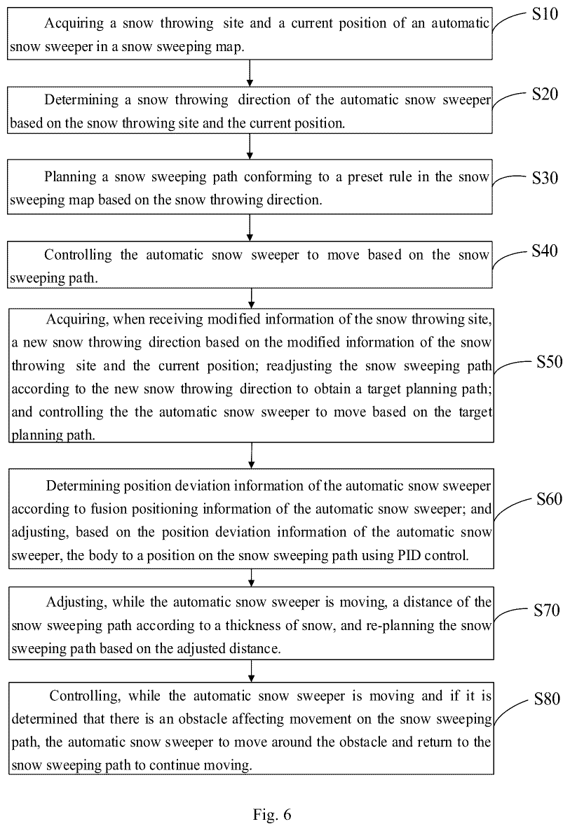

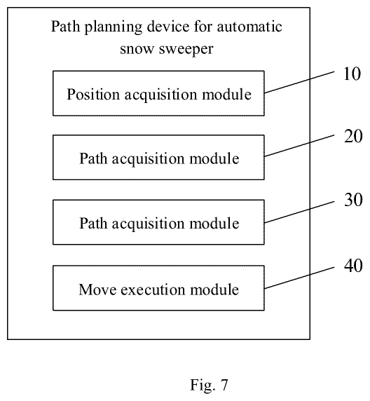

FIG. 6 shows a flowchart of a path planning method according to the third embodiment of present application, and based on the first embodiment shown in FIG. 3, the third embodiment of the path planning method of the present application is proposed.

In the third embodiment, after the Step S40, it further includes:

Step S50: acquiring, when receiving modified information of the snow throwing site, a new snow throwing direction based on the modified information of the snow throwing site and the current position; readjusting the snow sweeping path according to the new snow throwing direction to obtain a target planning path; and controlling the automatic snow sweeper to move based on the target planning path.

It should be noted that in the process of moving or before moving, users may need to change the previous snow throwing site or the sweeper determines that the current snow throwing site is no longer suitable as the snow throwing site, and then re-determine a new snow throwing site, generate a new snow throwing direction based on the new snow throwing site and the current position of the sweeper, determine the potential energy of each grid in the snow sweeping map based on the new snow throwing direction, and determine the target planning path based on the potential energy of each grid, so as to determine that the new bow-shaped cleaning path is appropriate and efficient.

In the third embodiment, after the Step S40, it further includes:

Step S60: determining position deviation information of the automatic snow sweeper according to fusion positioning information of the automatic snow sweeper; and adjusting, based on the position deviation information of the automatic snow sweeper, the body to a position on the snow sweeping path using PID control.

It should be noted that the fusion positioning information could be the positioning information obtained based on various sensors and GPS-RTK.

It should be understood that the position deviation (that is, the deviation from the original preset path) may be caused by the snow on the ground during the moving of the automatic snow sweeper, so it is necessary to control the body in a straight line. Here, the straight line control means that when driving along the road in a straight line, the car will focus on a far point on the forward path, so as to ensure that the car can move in a straight line. This method is also considered to be adopted for the automatic snow sweeper of the present application.

In specific implementation, the position of the sweeper is adjusted based on the position deviation information and PID control mode, and the position deviation information refers to the deviation data formed from the original path direction. For example, the current moving direction of the automatic snow sweeper is direction 1, but the fixed direction in the path is direction 2, thus the direction 1 needs to be adjusted to direction 2 by adjusting the angular speed. In addition, in the process of adjusting the angular speed, the linear speed also needs to be adjusted. The larger the angular speed adjustment is (adjusting in a manner of turning around its own center, the larger the adjustment angle is, the larger the angular speed is), the smaller the linear speed adjustment is. In general, the linear speed is 0.3 m/s by default, the highest is 0.4 m/s, and the lowest is 0.2 m/s.

Furthermore, the step of adjusting, based on the position deviation information of the automatic snow sweeper, the body to a position on the snow sweeping path using PID control includes:
determining a deviation angle of the automatic snow sweeper based on the current position of the automatic snow sweeper and a target point on the snow sweeping path;
determining a linear speed and an angular speed of the automatic snow sweeper based on the deviation angle of the automatic snow sweeper; and
adjusting the position of the body on the snow sweeping path based on the linear speed and angular speed of the automatic snow sweeper.

It should be understood that the current position refers to the current position point of the automatic snow sweeper on the snow sweeping path, and at the beginning, the position point is the starting point; The target point refers to the position point that the automatic snow sweeper needs to reach the planned snow sweeping path.

More specifically, the control logic of PID control mode is: assuming that the starting point (current position) is A, the target point is B, the sweeper point is C, the projection point of point C on the straight line AB is C′, the target point is D (D is on the straight line AB, and its distance from C′ is adjustable from 0.2 m to 1 m), the body orientation angle is phi, and the theta value controlled by pid is the included angle between the body orientation and the target straight line CD, that is, the deviation value of the automatic snow sweeper: theta=A (current heading angle)−B {CD}; Angular speed: rev=Kp*theta+Ki*integral (integral of deviation value)+Kd*derivative (differential of deviation value); Linear speed: vel=preset maximum speed*sqrt{1−(rev/preset maximum angular speed)\hat{ }{2}}; and Kp, Ki and Kd are all parameters.

In the third embodiment, after the Step S40, it further includes:

Step S70: adjusting, while the automatic snow sweeper is moving, a distance of the snow sweeping path according to a thickness of snow, and re-planning the snow sweeping path based on the adjusted distance.

It should be noted that when the thickness of snow is relatively large, the distance of the bow-shaped cleaning in the planned path can be reduced to facilitate the sweeper's movement, as pushing the sweeper is arduous. When the thickness of snow is relatively small, the distance of the bow-shaped cleaning in the planned path can be adjusted to be larger. In addition, the current thickness of the snow can be determined by the current in the shovel motor. When the thickness of the snow is relatively large, the required current is greater, and the maximum distance of the bow-shaped cleaning for the automatic snow sweeper is the width of the shovel head.

It should be understood that the distance of the bow-shaped cleaning of the automatic snow sweeper can be adjusted by users. The current snow thickness can be determined by a visual sensor or a laser radar, and the visual sensor or the laser radar can identify the distance between two points on the same vertical plane to determine the current snow thickness. The speed of snow sweeping can be adjusted according to the thickness of snow. If the current of the snow shovel is large, it means that the load is heavy. In this case, it is necessary to reduce the speed to ensure that it is clean and there is no full load and overcurrent.

In the third embodiment, after the Step S40, it further includes:

Step S80: controlling, while the automatic snow sweeper is moving and if it is determined that there is an obstacle affecting movement on the snow sweeping path, the automatic snow sweeper to move around the obstacle and return to the snow sweeping path to continue moving.

It should be noted that the preset recognition devices include but are not limited to visual sensors, laser radars or millimeter-wave radars. In the process of moving, obstacles can be identified by visual sensors or laser radar or millimeter wave radar. In this embodiment, the obstacle can be recognized by a collision sensor. Here, some obstacles may be hidden in the snow, and can be recognized after being touched when the sweeper is moving. After the collision sensor collides, the visual sensor, laser radar or infrared temperature sensor determines whether the obstacle belongs to a living thing. If it does not belong to a living thing, it moves around the obstacle and returns to the planned path. If it belongs to a living thing, it stops moving. Understandably, the purpose of detecting living things is to prevent the sweeper from causing harm to living things while also ensuring the safety use of the sweeper. After the collision sensor collides, stop moving and start moving again after receiving the confirmation information from the user.

Usually, there could be a plurality of cameras (preset recognition devices) on the automatic snow sweeper, which are installed at the front, left and right positions of the automatic snow sweeper to monitor the environment in different directions. Here, the specific ways to determine a living thing through the cameras may be as follows: pedestrians appear within 5 meters (preset distance) of the front camera, automatic planning is suspended, the snow shovel is stopped, and machine voice prompts pedestrian detection; pedestrians appear within 5 meters of the left camera and the snow is about to be thrown to the left, the automatic planning is suspended, the snow shovel is stopped, and machine voice prompts pedestrian detection; pedestrians appear within 5 meters of the right camera and the snow is about to be thrown to the right, the automatic planning is suspended, the snow shovel is stopped, and machine voice prompts pedestrian detection.

In the third embodiment, when receiving the modified information of the snow throwing site, the automatic snow sweeper will calculate the new snow throwing direction according to the new information and the current position. This ensures that the sweeper operates according to the latest snow throwing requirements. Based on the new snow throwing direction, the snow sweeping path is readjusted to generate the target planning path. This can ensure the coverage and uniformity of snow throwing, enabling snow to be removed efficiently. Based on the target planning path, the automatic snow sweeper will move automatically. Through the built-in navigation and positioning system, the sweeper can perceive its own position in real time and adjust its movement direction, speed and trajectory to ensure accurate movement according to the planned path. In the process of automatic movement, the automatic snow sweeper will adjust its position according to the fusion positioning information to keep the accurate position of the sweeper on the snow sweeping path. This RTK-odometry-IMU fusion positioning information may include GPS, IMU, odometer and other information. According to the thickness of snow, the automatic snow sweeper can dynamically adjust the distance of the snow sweeping path. If the snow layer is thick, the distance may be appropriately increased to improve the snow removal efficiency. Conversely, if the snow layer is thin, the distance may be reduced to ensure that the snow can be completely removed. In the process of automatic movement, if an obstacle affecting the movement is detected, the automatic snow sweeper will judge based on the sensor information and go around the obstacle. The sweeper will return to the snow sweeping path and proceed in the intended direction of snow cleaning once the obstacle has been avoided. The aforementioned procedures enable the automatic snow sweeper to be intelligently adjusted in response to various information and circumstances, resulting in the accomplishment of autonomous, accurate, and efficient snow sweeping tasks. This adaptability and flexibility can improve work efficiency in different snow cleaning scenarios and ensure the safety and reliability of snow sweeping operations.

In addition, FIG. 6 shows the embodiment of the application also provides a path planning device, which includes:
a position acquisition module 10, configured for acquiring a snow throwing site and a current position of an automatic snow sweeper in a snow sweeping map;
a path acquisition module 20, configured for planning a snow sweeping path conforming to a preset rule in the snow sweeping map based on the snow throwing direction; and
a path acquisition module 30, configured for planning a snow sweeping path conforming to a preset rule in the snow sweeping map based on the snow throwing direction; and
a move execution module 40, configured for controlling the automatic snow sweeper to move based on the snow sweeping path.

This embodiment is realized as follows: acquiring a snow throwing site and a current position of an automatic snow sweeper in a snow sweeping map; determining a snow throwing direction of the automatic snow sweeper based on the snow throwing site and the current position; planning a snow sweeping path conforming to a preset rule in the snow sweeping map based on the snow throwing direction; and controlling the automatic snow sweeper to move based on the snow sweeping path. In this way, the snow sweeping path is optimally planned for the automatic snow sweeper, and the snow sweeping efficiency of the automatic snow sweeper is improved.

Other embodiments or specific implementations of the path planning device provided by this application are not duplicated here, but can be found in the aforementioned method embodiments.

In addition, it should be noted that in this paper, the terms “comprise”, “include” or any other variation thereof are intended to cover non-exclusive subject-matter. A process, method, article or system including a series of elements includes not only those elements, but also other elements not explicitly listed, or elements inherent to such process, method, article or system. Without more restrictions, an element defined by the phrase “comprising a” does not exclude the existence of other identical elements in the process, method, article or system.

The above numbers of the embodiments of the present application are only for description, and do not indicate priorities of the embodiments. In the claim listing several devices, several of these devices can be represented by one and the same item of hardware. The usage of the phrases first, second, and third does not indicate order and might be read as names.

With the description of the above embodiments, those skilled in the art can clearly understand that the methods of the above embodiments can be realized by means of software and necessary general hardware platform. Alternatively, they can be realized by hardware, but in many cases, the former is the better one. Based on this understanding, the technical solution of this application can be embodied in the form of a software product, which is stored in a storage medium, such as Read Only Memory (ROM), RAM, magnetic disk, optical disk, etc., and includes several instructions to enable a terminal device (e.g., mobile phone, computer, server, air conditioner, or network device, etc.) to execute the methods described in the embodiments of this application.

The above are merely the preferred embodiments of the present application, they do not restrict the patent scope of this application. Any equivalent structure or equivalent process transformation made with the contents of this application description and drawings, or directly or indirectly used in other related technical fields, shall be included in the patent protection scope of this application.

What is claimed is:

1. A path planning method, comprising:
acquiring a snow throwing site and a current position of an automatic snow sweeper in a snow sweeping map;
determining a snow throwing direction of the automatic snow sweeper based on the snow throwing site and the current position;
planning a snow sweeping path conforming to a preset rule in the snow sweeping map based on the snow throwing direction; and
controlling the automatic snow sweeper to move based on the snow sweeping path.

2. The method of claim 1, wherein before the step of acquiring a snow throwing site and a current position of an automatic snow sweeper in a snow sweeping map, the method further comprises:
acquiring latitude and longitude coordinates of a target snow throwing area and a target snow sweeping area by using a multi-sensor fusion positioning technology, and converting the latitude and longitude coordinates into a snow sweeping map coordinate system based on an origin; and
performing rasterization and potential field on the target snow throwing area and the target snow sweeping area based on the snow sweeping map coordinate system to generate a snow sweeping map.

3. The method of claim 1, wherein the step of planning a snow sweeping path conforming to a preset rule in the snow sweeping map based on the snow throwing direction comprises:
determining whether the snow sweeping map has a plurality of snow sweeping areas;
determining, if the plurality of snow sweeping areas exist, whether the plurality of snow sweeping areas constitute a connected area;
determining, if the connected area is constituted, a connection path connecting two adjacent snow sweeping areas; and
planning a snow sweeping path conforming to a preset rule in the snow sweeping map based on the snow throwing direction and the connection path.

4. The method of claim 1, wherein the step of controlling the automatic snow sweeper to move based on the snow sweeping path comprises:
controlling the automatic snow sweeper to move from an area with high potential energy to an area with low potential energy;
the step of controlling the automatic snow sweeper to move from an area with high potential energy to an area with low potential energy further comprises:
controlling the automatic snow sweeper to clean an outer circle of the snow throwing site and throw the snow from the outer circle to an inner circle of the snow throwing site; and
controlling the automatic snow sweeper to move from an area with high potential energy to an area with low potential energy in the inner circle of the snow throwing site.

5. The method of claim 4, wherein the step of controlling the automatic snow sweeper to move from an area with high potential energy to an area with low potential energy in the inner circle of the snow throwing site comprises:
controlling the automatic snow sweeper to clean an area where snow cannot be thrown into the snow throwing site in a manner of moving from the area with high potential energy to the area with low potential energy, and then throw the snow to an uncleaned area in the inner circle of the snow throwing site; and
controlling the automatic snow sweeper to re-clean the uncleaned area where snow can be thrown into the snow throwing site in the manner of moving from the area with high potential energy to the area with low potential energy.

6. The method of claim 1, wherein after controlling the automatic snow sweeper to move based on the snow sweeping path, the method further comprises:
acquiring, when receiving modified information of the snow throwing site, a new snow throwing direction based on the modified information of the snow throwing site and the current position;
readjusting the snow sweeping path according to the new snow throwing direction to obtain a target planning path; and
controlling the automatic snow sweeper to move based on the target planning path.

7. The method of claim 1, wherein after controlling the automatic snow sweeper to move based on the snow sweeping path, the method further comprises:
determining position deviation information of the automatic snow sweeper according to fusion positioning information of the automatic snow sweeper; and
adjusting, based on the position deviation information of the automatic snow sweeper, the body to a position on the snow sweeping path using PID (Proportion Integration Differentiation) control.

8. The method of claim 7, wherein the step of adjusting, based on the position deviation information of the automatic snow sweeper, the body to a position on the snow sweeping path using PID control comprises:
determining a deviation angle of the automatic snow sweeper based on the current position of the automatic snow sweeper and a target point on the snow sweeping path;
determining a linear speed and an angular speed of the automatic snow sweeper based on the deviation angle of the automatic snow sweeper; and
adjusting the position of the body on the snow sweeping path based on the linear speed and angular speed of the automatic snow sweeper.

9. The method of claim 8, wherein the deviation angle is an included angle between a current heading angle of the automatic snow sweeper and a target straight line; the target straight line is a connecting line between a first projection point of the current position of the automatic snow sweeper on a preset straight line and a second projection point of the target point on the preset straight line; the preset straight line is a connecting line between a starting point and the target point of the automatic snow sweeper.

10. The method of claim 1, wherein after controlling the automatic snow sweeper to move based on the snow sweeping path, the method further comprises:
adjusting, while the automatic snow sweeper is moving, a distance of the snow sweeping path according to a thickness of snow, and re-planning the snow sweeping path based on the adjusted distance.

11. The method of claim 1, wherein after controlling the automatic snow sweeper to move based on the snow sweeping path, the method further comprises:
controlling, while the automatic snow sweeper is moving and if it is determined that there is an obstacle affecting movement on the snow sweeping path, the automatic snow sweeper to move around the obstacle and return to the snow sweeping path to continue moving.

12. The method of claim 1, wherein after controlling the automatic snow sweeper to move based on the snow sweeping path, the method further comprises:
pausing, when a pedestrian is recognized by at least one preset recognition device in the automatic snow sweeper at different positions, and/or if it is determined that snow has been thrown to a position corresponding to the preset recognition device, the automatic snow sweeper.

13. A path planning device, comprising:
a position acquisition module, configured for acquiring a snow throwing site and a current position of an automatic snow sweeper in a snow sweeping map;
a direction acquisition module, configured for determining a snow throwing direction of the automatic snow sweeper based on the snow throwing site and the current position;
a path acquisition module, configured for planning a snow sweeping path conforming to a preset rule in the snow sweeping map based on the snow throwing direction; and
a move execution module, configured for controlling the automatic snow sweeper to move based on the snow sweeping path.

14. The path planning device of claim 13, wherein the device is further configured for:
acquiring latitude and longitude coordinates of a target snow throwing area and a target snow sweeping area by using a multi-sensor fusion positioning technology, and converting the latitude and longitude coordinates into a snow sweeping map coordinate system based on an origin;
performing rasterization and potential field on the target snow throwing area and the target snow sweeping area based on the snow sweeping map coordinate system to generate a snow sweeping map.

15. The path planning device of claim 13, wherein the path acquisition module is further configured for:
determining whether the snow sweeping map has a plurality of snow sweeping areas;
determining, if the plurality of snow sweeping areas exist, whether the plurality of snow sweeping areas constitute a connected area;
determining, if the connected area is constituted, a connection path connecting two adjacent snow sweeping areas; and
planning a snow sweeping path conforming to a preset rule in the snow sweeping map based on the snow throwing direction and the connection path.

16. An automatic snow sweeper, comprising: a moving machine, a snow removal machine, a body and one or more control devices, wherein one or more control devices comprise a memory, a processor and a path planning program stored in the memory and executable on the processor, and the path planning program is configured to realize the following steps:
acquiring a snow throwing site and a current position of the automatic snow sweeper in a snow sweeping map;
determining a snow throwing direction of the automatic snow sweeper based on the snow throwing site and the current position;
planning a snow sweeping path conforming to a preset rule in the snow sweeping map based on the snow throwing direction; and
controlling the automatic snow sweeper to move based on the snow sweeping path.

17. The automatic snow sweeper of claim 16, wherein cameras are arranged at front, left and right sides of the automatic snow sweeper, and after the camera detects a pedestrian, the control device controls to stop the snow removal machine.

18. The automatic snow sweeper of claim 16, wherein the path planning program is configured to further realize the following steps:
acquiring latitude and longitude coordinates of a target snow throwing area and a target snow sweeping area by using a multi-sensor fusion positioning technology, and converting the latitude and longitude coordinates into a snow sweeping map coordinate system based on an origin; and
performing rasterization and potential field on the target snow throwing area and the target snow sweeping area based on the snow sweeping map coordinate system to generate a snow sweeping map.

19. The automatic snow sweeper of claim 16, wherein when planning a snow sweeping path conforming to a preset rule in the snow sweeping map based on the snow throwing direction, the path planning program is configured to realize the following steps:
determining whether the snow sweeping map has a plurality of snow sweeping areas;
determining, if the plurality of snow sweeping areas exist, whether the plurality of snow sweeping areas constitute a connected area;
determining, if the connected area is constituted, a connection path connecting two adjacent snow sweeping areas; and
planning a snow sweeping path conforming to a preset rule in the snow sweeping map based on the snow throwing direction and the connection path.

20. The automatic snow sweeper of claim 16, wherein when controlling the automatic snow sweeper to move based on the snow sweeping path, the path planning program is configured to realize the following steps:
controlling the automatic snow sweeper to move from an area with high potential energy to an area with low potential energy;
the step of controlling the automatic snow sweeper to move from an area with high potential energy to an area with low potential energy comprises:
controlling the automatic snow sweeper to clean an outer circle of the snow throwing site and throw the snow from the outer circle to an inner circle of the snow throwing site; and
controlling the automatic snow sweeper to move from an area with high potential energy to an area with low potential energy in the inner circle of the snow throwing site.
